(19) United States
(12) Patent Application Publication
(10) Pub. No.: US 2025/0236314 A1
(43) Pub. Date: Jul. 24, 2025

(54) MODEL PREDICTIVE PATH INTEGRAL CONTROLLER GUIDED BY LARGE VISION LANGUAGE MODEL FOR INTELLIGENT AUTONOMOUS VEHICLE PATH PLANNING

(71) Applicants: Constructor Autonomous AG, Schaffhausen (CH); Constructor Education and Research Genossenschaft, Schaffhausen (CH)

(72) Inventors: Aleksandr Buyval, Bremen (DE); Ruslan Mustafin, Tbilisi (GE); Ilya Shimchik, Zurich (CH); Maksim Liubimov, Belgrade (RS); Serg Bell, Costa del Sol (SG); Stanislav Protasov, Singapore (SG); Laurent Dedenis, Singapore (SG); Nikolay Dobrovolskiy, Istambul (TR)

(21) Appl. No.: 18/417,553

(22) Filed: Jan. 19, 2024

(51) Int. Cl. B60W 60/00; G06F 40/10; G06F 40/40; G06N 7/01; G06V 10/82; G06V 20/56

(52) U.S. Cl. CPC B60W 60/0011; G06F 40/10; G06F 40/40; G06N 7/01; G06V 10/82; G06V 20/56; B60W 2420/403; B60W 2420/408; B60W 2556/50

(57) ABSTRACT

Systems and methods for autonomous-vehicle navigation using a large vision language model (LVLM) to understand road situations and construct a guide for the autonomous vehicle's planning system and Model Predictive Path Integral (MPPI) controller. The LVLM analyzes image data from driving scenarios and generates driving suggestions. The LVLM is pre-trained on a dataset of image-pairs and fine-tuned with specific driving scenarios to optimize performance.

### TECHNICAL FIELD

The present invention relates to the field of autonomous vehicles and intelligent transportation systems, and specifically, improved navigation techniques that use machine learning models to optimize vehicle navigation.

### BACKGROUND

Model Predictive Path Integral (MPPI) control is a sample-based optimization method that rolls out numerous possible trajectories, estimates their costs, and calculates the best trajectory from among the possible trajectories. MPPI operates by repeatedly optimizing a control trajectory to minimize a cost function, taking into account a predictive model of the system and its future states. MPPI combines the advantages of model predictive control and stochastic optimization, making it suitable for tasks with complex dynamics and uncertainty. MPPI has found applications in areas such as robotic motion planning, autonomous vehicles, and reinforcement learning. Typical MPPI costs include track costs, which depend on the car's position. Other costs comprise collision costs, dynamic state costs, and goal costs. The major challenge of MPPI is balancing these costs. For instance, when a car is parked in the same lane as a moving autonomous vehicle, a move to an adjacent lane for passing may be indicated. But if the track cost for the adjacent lane is too high and the goal cost is low, the MPPI controller may stop and wait next to the parked car. Conversely, if the opposite conditions exist, the MPPI controller may attempt to overtake the parked car, even if doing so violates traffic rules. Correctly understanding the road situation while considering all traffic restrictions remains a challenging task.

A typical approach is to use a rule-based system that analyzes data from a perception system and a map system, and infers decisions to be used as input by MPPI. But this approach requires a significant amount of effort to create the necessary rules for all possible road cases. Additionally, maintaining consistency and clarity in all the rules is challenging.

Another approach is to use data-driven methods to learn all required rules and behaviors from data. However, this approach faces challenges due to the immense amount of data required for effective learning. Moreover, testing and interpreting the decisions that have been made can be difficult. One example of using such an approach is Comma.AI and its open source driver assistance system. Currently, openpilot performs the functions of Adaptive Cruise Control (ACC), Automated Lane Centering (ALC), Forward Collision Warning (FCW), and Lane Departure Warning (LDW) for a growing variety of supported car makes, models, and model years. Comma.AI uses data-driven methods to calculate the planned path from two camera images.

A third approach is to use LVLMs to augment LLM text-based reasoning with visual inputs and perform visual-textual reasoning on the road scenes. In this setting an LLM is used as a general-purpose reasoning engine. Large Language Models (LLMs) have shown promising results in interpreting not only natural language sentences but also images. They are also capable of producing output in predefined structures suitable for further processing by other algorithms. For example, recent models such as Kosmos-2 and LLaVA (Large Language and Vision Assistant) allow users to query images with natural language and ask for description of an image. LLMs excel at reasoning and inference of relations between objects. But pure text-based LLMs are not applicable in the self-driving setting because they lack an ability to perform reasoning about the current environment. LVLMs (Large Vision-Language Models) address this challenge by extracting and then fusing visual information into the stream of text tokens, grounding all text based reasoning in the currently visible context.

But abstract reasoning is not very useful in the context of self-driving, so one solution, LINGO-1, fuses camera information into a stream of text tokens. This enables an LLM to perform reasoning in the context of currently visible objects, such as pedestrians, other vehicles and traffic signs. But the main purpose of LINGO-1 is commenting and interacting with the user, not with optimizing vehicle navigation. New techniques for optimizing navigation are needed that achieve more reliable and efficient results in real time.

### SUMMARY

Systems and methods for autonomous vehicle navigation using an LVLM and an MPPI controller solve the aforementioned problems of existing solutions for optimizing navigation. In an embodiment, a method comprises collecting image data along the path with a camera operably coupled to the autonomous vehicle in motion and passing a slice of collected image data encoded with a feature extractor to an LVLM. The LVLM in this embodiment has been pretrained and tuned with image-text pairs from driving environments. A text-based query related to an aspect of driving is passed to the LVLM. The LVLM outputs driving instructions in a structured, machine-readable format. These driving instructions from the LVLM are passed to a Model Predictive Path Integral (MPPI) module operably coupled to the autonomous vehicle. The MPPI module calculates a plurality of possible paths using a cost model. The MPPI module does this by parsing the driving instructions from the LVLM and inputting the parsed driving instructions into the cost model. The MPPI module assigns a change in cost of one of the plurality of possible calculated paths based on the driving instructions from the LVLM. Then the MPPI module selects the lowest cost path from among the possible calculated paths based on the change in cost assigned by the MPPI module.

Variations on this method include an embodiment where the text-based query is a prompt sent in accordance with a predetermined schedule, for example each 100 ms. The driving instructions may comprise a scene description and an object description. The LVLM may be pre-trained on a dataset comprising video/image-caption pairs, wherein the video/image caption pairs comprise images commonly observed on roadways combined with text captions. The images commonly observed on roadways may comprise images of crosswalks, traffic lights, signs, pedestrians, and other vehicles. In an embodiment, selecting the lowest cost path includes applying an optimizer using a Monte Carlo approximation. The LVLM may be tuned on a dataset comprising visual-instruction pairs, wherein images commonly observed on roadways are linked with instructions and the instructions may comprise commands to stop or to use caution.

Variations for the system include a text-based query that comprises a prompt sent in accordance with a predetermined schedule. The driving instructions may comprise a scene description and an object description. The LVLM may be pre-trained on a dataset comprising video/image-caption pairs, wherein the video/image-caption pairs comprise images commonly observed on roadways, combined with text captions. The images commonly observed on roadways may comprise images of crosswalks, traffic lights, signs, pedestrians, and other vehicles. The LVLM may be tuned on a dataset comprising visual-instruction pairs, wherein visual instruction pairs comprise images commonly observed on roadways are linked with instructions. Instructions may comprise commands to stop or to use caution. The plurality of sensors may comprise a camera, LiDAR, radar, and GPS. And the LVLM may be built from a generative pretrained transformer.

In an alternative embodiment, the method focuses on training a Large Language Model (LLM) for trajectory calculation when integrated with an MPPI controller. The method comprises providing a first dataset of image pairs to the LLM, wherein the image pairs comprise images from roadway scenarios and text labels. The method also comprises providing a second dataset of images paired with driving instructions or information related to the self-driving vehicle. The LLM is trained on the first dataset and fine-tuned on the second dataset. The model is tested by passing an image of a roadway scenario to the LLM and prompting the LLM with a text query related to the image from a roadway scenario. The LLM outputs, and an MPPI controller receives, a driving instruction in response to the text query in a structured, machine-readable format. The driving instruction is parsed and passed as an input to a cost model. In one variation, the LLM chosen for training is a generative pretrained transformer. In an embodiment, the method also comprises calculating a plurality of possible paths using a cost model. In an embodiment, selecting a lowest cost path from among the plurality of possible paths is based on a change in cost assigned by the MPPI module.

### BRIEF DESCRIPTION OF THE DRAWINGS

FIG. 1 is a block diagram of a system for navigating a path by an autonomous vehicle in motion, according to an embodiment.

FIG. 2 is a diagram of an implementation of an integrated LVLM with an MPPI controller in a first driving scenario, according to an embodiment.

FIG. 3 is a diagram of an implementation of an integrated LVLM with an MPPI controller in a second driving scenario, according to an embodiment.

FIG. 4 is a block diagram of a system with an autonomous vehicle represented by a state vector, according to an embodiment.

FIG. 5 is flowchart of a method for navigating a path by an autonomous vehicle in motion, according to an embodiment.

FIG. 6 is a diagram of a roadway scenario showing alternative paths for an autonomous vehicle related to cost functions, according to an embodiment.

### DETAILED DESCRIPTION

Systems and methods integrate a Model Predictive Path Integral (MPPI) controller with a Large Vision Language Model (LVLM) to enhance the path planning and decision-making capabilities of autonomous vehicles. Systems and methods are directed towards improving the safety, efficiency, and adaptability of autonomous vehicles when navigating complex and dynamic environments, including scenarios involving pedestrian interactions and other road users.

The capability of the LVLM for scene understanding enables correct decision-making. By employing specific prompts, the LVLM outputs have a specific format, such as JSON, that can be easily parsed by the MPPI controller.

The use of an MPPI controller allows for integrating high-level guidance into the planning process. For example, if the LVLM output indicates that a change to a new lane cannot be made, the MPPI increases the track cost for the trajectories in that lane to discourage the optimizer from entering the new lane. Different sets of cost coefficients for the MPPI controller are supplied based on traffic situations identified by the LVLM.

MPPI is a sampling-based model predictive control algorithm. The cost function for MPPI is a quadratic function of the state and control variables. The cost function is used to minimize the distance to the desired state, the velocity, and the distance to obstacles. MPPI can optimize cost functions that are hard to approximate as quadratic functions along nominal trajectories. The input of the cost function is the state of the system. The output of the cost function is a scalar value that represents the cost of a given state. The cost function is used to evaluate different states and choose the one with the lowest cost.

MPPI is used to control autonomous vehicles by generating a trajectory that minimizes a cost function. Trajectories and costs are related. The cost of a trajectory is a function of the states visited by the trajectory. The goal of trajectory optimization is to find a trajectory that minimizes the cost. Thus, the cost function can be used to evaluate the quality of a trajectory.

The output of the MPPI controller comprises control signals. Control signals are a function of the state of the system, the control costs, and noise. The control signals are calculated using an iterative algorithm that takes into account the uncertainty in system dynamics. The first control input from the sequence of control signals is sent to one or more actuators of the autonomous vehicle. After that, the control system receives state feedback and iterations can repeat. In embodiments, other non-iterative types of algorithms or functions can be used, including recursive functions for a single vehicle.

Iteration refers to the process of repeatedly running the MPPI algorithm to improve the control policy. The MPPI algorithm works by first predicting the future state of the system based on the current state and a set of control inputs. Then, the algorithm computes a cost function that measures how well the predicted state matches the desired state. Finally, the algorithm updates the control inputs to minimize the cost function. The iteration process is repeated until the cost function is minimized and the desired state is achieved. The number of iterations required to achieve the desired outcome depends on the complexity of the system and the accuracy of the predictions.

In an embodiment, the LVLM model is built from a pre-trained language model (LLM). The transformer architecture is a model in machine learning, specifically designed for natural language processing, that processes sequences of data, such as text, in parallel rather than sequentially. This design incorporates an attention mechanism, which enables the model to weigh different parts of the input differently, improving its ability to capture relationships within the data. A Generative Pretrained Transformer (GPT) is an application of this architecture, focusing on generating text. GPT models are pretrained on large datasets, allowing them to generate contextually rich and coherent text across various language tasks. These models utilize the transformer's parallel processing and attention capabilities to analyze and produce language, handling tasks like translation, content creation, and conversational responses. The LLM is used to give the LVLM a foundation for understanding text-based language. The LVLM is then created by fine-tuning on a dataset comprising vision-and-language pairs. For example, a vision-language pair is a video of a pedestrian crossing a road with the text “A pedestrian is crossing the road.”

The fine-tuning teaches the LLM how to combine information from images and text and builds the LVLM. There are a variety of ways to train an LLM with video images. One approach is to use a pre-trained language model (LLM) and fine-tune the model on a dataset of video-caption pairs. This can be effective, but it can also be time-consuming and computationally expensive. Another approach is to use a self-supervised learning method. In this approach, the LLM is trained to predict the next frame in a video sequence. This approach can be more efficient than fine-tuning an LLM on a dataset of video-caption pairs, but it can also be less effective. Finally, an LVLM can also be trained from scratch. This approach is the most challenging, but it can also be the most effective. In this approach, the LVLM is trained on a dataset of video-caption pairs, and is also trained on a dataset of other tasks, such as image classification and object detection.

The LLM is trained with video images to create a LVLM. In an embodiment, a pre-trained LLM is used and fine-tuned on a dataset of video-text pairs. For example, an LLM such as LLaVA connects the visual encoder ViT-L/14 of Contrastive Language-Image Pre-Training (CLIP) with the language decoder LLaMA by a lightweight fully-connected (FC) layer. CLIP is a neural network trained on a variety of (image, text) pairs. It can be instructed in natural language to predict the most relevant text snippet, given an image, without directly optimizing for the task. In this example, LLaVA first trains the FC layer with 595K image-text pairs, and then fine-tunes the entire model on a dataset of image-text pairs.

In an embodiment, the LVLM is built using a two-stage training process. In the first stage, the model is pre-trained on a large general dataset of video/image-caption pairs. In the second stage, the model is fine-tuned on a dataset of visual-instruction pairs that contains examples specifically from the self-driving domain. A video/image-caption pair consists of a video clip and a corresponding image caption. The video clip can be a short video clip or a full-length movie. The image caption is a short description of the video clip. Such a model can generate reference expressions that accurately describe objects in images. The model can also answer questions about objects in images. In an embodiment, the first dataset of video/image-caption pairs comprises images commonly observed on roadways such as crosswalks, traffic lights, signs, pedestrians, or other vehicles, combined with text captions. The visual-instruction pairs for the second dataset comprise similar as the first dataset but linked with instructions. For example, a red stoplight or a pedestrian in a crosswalk is linked with “stop.”

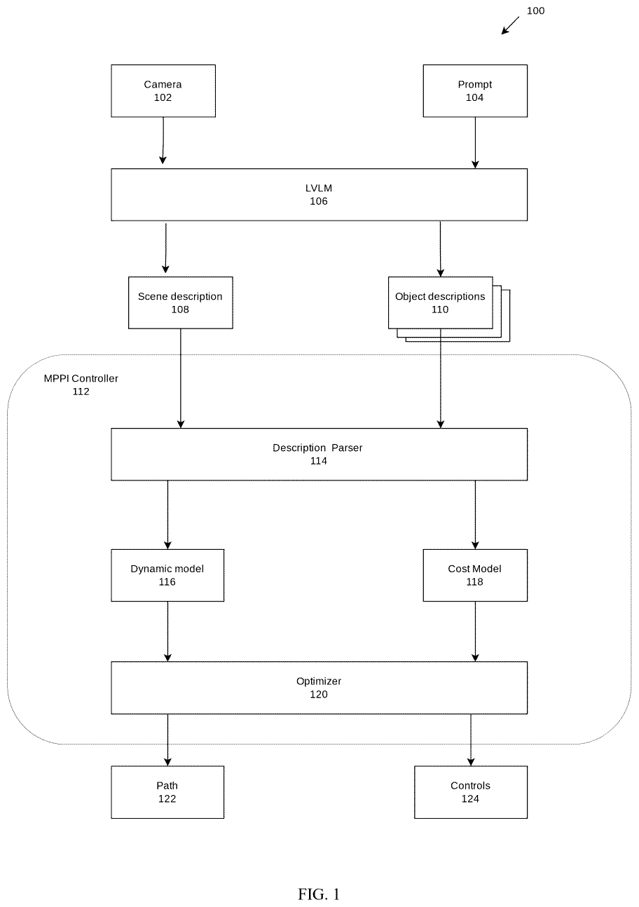

The trained LVLM model is integrated with the MPPI control system. A block diagram of an exemplary system 100 embodiment is shown in FIG. 1. The system tracks a queue of past camera frames captured by camera 102. A slice of N past frames is encoded with a feature extractor and submitted as an input to the LVLM module 106. A “slice” of camera frames refers to a sequential set of images captured by the vehicle's cameras over a brief time period. This sequence provides real-time environmental data, capturing the dynamics of the surroundings, including moving objects like pedestrians and other vehicles. These frames are processed to understand and predict the scenario around the vehicle. The LVLM module 106 accepts a sequence of encoded camera images along with text based queries related to various aspects of driving: road condition, availability of the left and right lanes, is there a pedestrian in the roadway, is another vehicle close by, and so on. The LVLM module 106 outputs driving recommendations in a structured, machine-readable format such as JSON or YAML.

Recommendations are generated because camera images and prompts 104 are linked. For example, a recommendation can link another car in the same lane with adjusting speed or stopping recommendation(s). Or a pedestrian moving toward a crosswalk can be linked to stopping to let the pedestrian cross. The output of the description-recommendation is structured, for example by using JSON format. The format is used to convert recommendations as data inputs for the MPPI controller. The LVLM can be given specific prompts at regular intervals, such as “please describe the intention of each object on the road” or “do you see anything dangerous?” For example, when the LVLM sees a pedestrian near the roadway, a caution recommendation is given when the pedestrian is close. A danger recommendation is given when a pedestrian starts to move toward and enter the crosswalk.

The LVLM outputs both scene descriptions 108, such as “lane available,” and object descriptions 110. Object descriptions 110 concern the environment, such as road conditions. For example, the LVLM has been queried about danger in the environment, which is linked with wet roads. The LVLM outputs a recommendation of caution in the form of reducing the estimated coefficient of friction. Object descriptions 110 generally comprise outputs based on inputs from the perception system. In an embodiment, descriptions are formulated in JSON, or another structured format. The structured format simplifies passing data to other controllers and processing that data.

The output provided is then sent to the MPPI module 112, which adjusts coefficients in its planning to optimize the trajectory based on the scene description. The description parser 114 converts the descriptions to inputs for the dynamic model 116 and cost model 118. Cost model 118 is a representation of the environment in which the car is driving. It is used to calculate the cost of a trajectory, which is a path that the car could take. The cost of a trajectory is determined by a number of factors, including the distance traveled, the smoothness of the path, and the avoidance of obstacles. The cost model is created by combining a prior map with a camera image. The prior map is a map of the environment that is created from data such as GPS coordinates and elevation data. The camera image is used to create a local cost map that represents the obstacles that are close to the car. The local cost map is then fused with the prior map to create a complete cost model. The cost model is used by the MPPI controller to determine the best trajectory for the car to take. The MPPI controller then uses this information to calculate the optimal trajectory that will minimize the cost. The dynamic model 116 refers to the car itself and its capabilities. For example, road conditions and friction coefficients are dynamics for the current state and predict how the car will behave in the next 10 seconds. If the LVLM says that the road is bad—the coefficient affects how the car performs. If the friction coefficient is good, more potential trajectories will be available because of reduced cost. In embodiments, predictions can be made for other time periods, such as 1, 5, 15, 20, or 30 seconds, and so on.

Optimizer 120 considers the output of the cost-model 118 and the dynamic model 116. In an embodiment, the path integral is optimized using a Monte Carlo approximation. This involves sampling a large number of trajectories from the uncontrolled dynamics of the system, and then computing the optimal control as the trajectory that minimizes the expected cost over all of the sampled trajectories. The main advantage of using a Monte Carlo approximation is that it allows the path integral to be optimized for systems with high-dimensional state spaces. This is because the Monte Carlo approximation does not require the state space to be discretized, which can be a significant advantage for systems with a large number of states. However, the main disadvantage of using a Monte Carlo approximation is that it can be computationally expensive. This is because the number of trajectories that need to be sampled in order to obtain a good approximation of the optimal control can be very large.

The optimizer outputs are therefore the path 122, which comprises a trajectory and controls 124 comprising steering, acceleration, and braking. For example, if the road condition is wet, the module decreases the friction coefficient in the internal MPPI dynamic module. If the field “we should avoid a pedestrian” is true, the module sets a high value for the track cost coefficient of trajectories that would bring the vehicle close to the pedestrian.

In an embodiment, all path calculation is performed locally on the car. This helps avoid uncertainty and latency. Alternatively, some parts of the autonomous driving system are distributed. For example, portions of the calculations can be distributed across non-car components, such as a base system operably coupled to the car, or with other distributed components that are communicatively coupled to the car (e.g. in the cloud). Autonomous driving hardware, such as NVIDA drivepx or similar, and camera sensors are used.

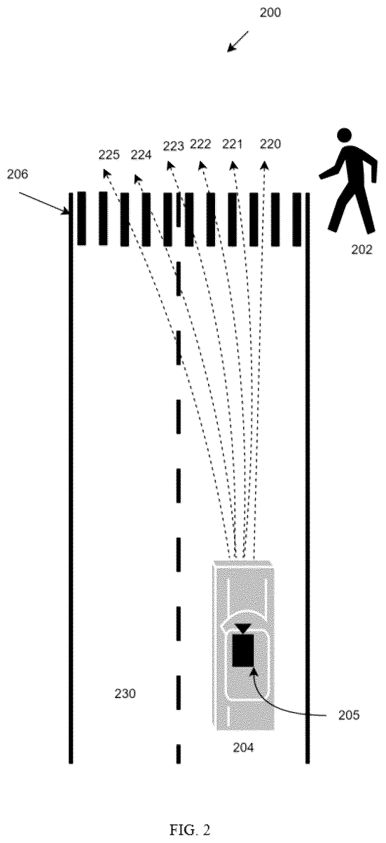

Referring to FIG. 2, a driving scenario 200 where pedestrian 202 is near autonomous vehicle 204 equipped with camera 205 is depicted, according to an embodiment. Crosswalk 206 is in front of autonomous vehicle 204 and there is a possibility that pedestrian 202 will enter crosswalk 206. Autonomous vehicle 204 is equipped with an MPPI controller. Paths 220-225 represent possible trajectories for autonomous vehicle 204. In scenario 200, pedestrian 202 is stationary and does not enter the crosswalk. Thus, images collected by camera 205 do not trigger any change in the relative cost of the possible trajectories 220-225. In this scenario, the cost coefficients of the possible trajectories may suggest that the optimal trajectory lies in the neighboring lane 230. This trajectory, for example, may put autonomous vehicle 204 in position to take an inside position for a turn ahead. The presence of pedestrian 202 is not factored into the cost function and the calculation of weights.

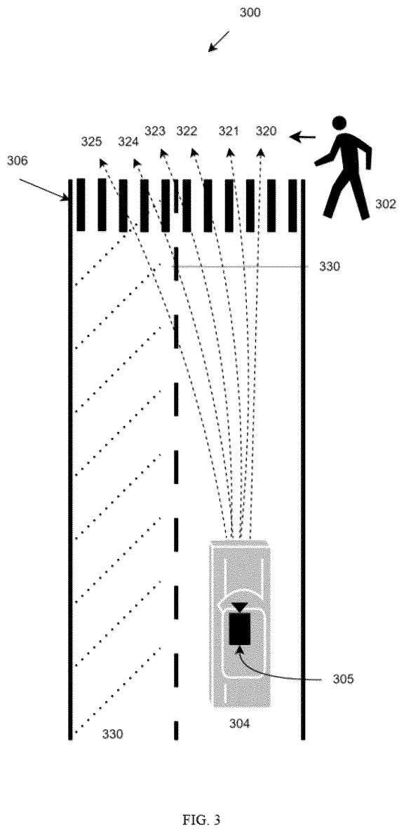

Referring to FIG. 3, an alternative driving scenario 300 where pedestrian 302 is near autonomous vehicle 304 equipped with camera 305 is depicted, according to an embodiment. Crosswalk 306 is in front of autonomous vehicle 304 and there is again a possibility that pedestrian 302 will enter the crosswalk. This time pedestrian 302 is in motion towards crosswalk 306. Camera image data records movement of pedestrian 302 and this image data is passed to the LVLM. A prompt is also passed to the LVLM, such as “do you see anything dangerous?” The LVLM outputs descriptions that become inputs for the MPPI controller's description parser. The description parser adjusts the cost model and dynamic model accordingly. Possible trajectories 320-325 are considered by the MPPI controller. As a result of the extra cost added as a result of pedestrian 302, trajectory 320 now becomes the most costly path. Trajectories 321-325 are progressively less costly than 320, but the combination of a pedestrian in a crosswalk is enough to make paths that cross into neighboring lane 320 too expensive to be chosen by the MPPI controller. In this scenario, the lowest cost path is stopping at imaginary line 330 and allowing pedestrian 302 to cross at crosswalk 306. This results because the LVLM has interpreted camera data and indicates that there is a pedestrian who is about to cross the road at a crosswalk, leading to an increase in the track cost of the neighboring lane. Therefore, from the optimizer's perspective, stopping is now the optimal solution.

Stopping is an optimal solution in the scenario where a pedestrian is in the crosswalk because the cost model penalizes trajectories that go near obstacles. The cost model penalizes trajectories that go near obstacles by assigning a high cost to those trajectories. The cost is calculated as a function of the distance between the trajectory and the closest obstacle. The closer the trajectory is to an obstacle, the higher the cost. The MPPI controller will avoid trajectories that go near obstacles and if the only way to avoid an obstacle is to stop, then the MPPI controller will choose to stop because this is the lowest cost option.

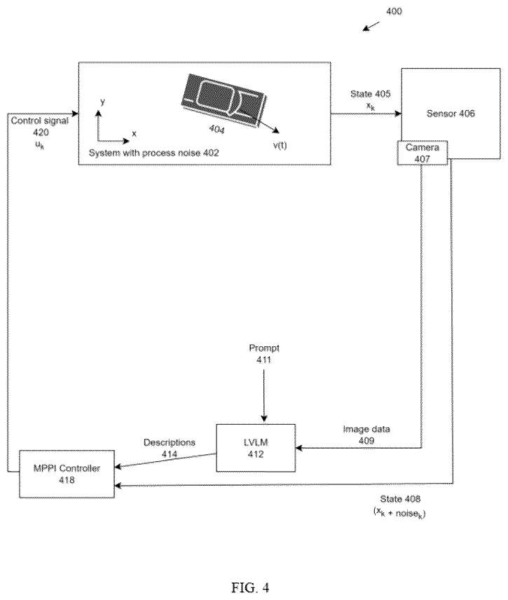

Referring to FIG. 4, a block diagram of a system 400 with an integrated LVLM and MPPI controller is depicted, according to an embodiment. In FIG. 4, system 402 comprises autonomous vehicle 404 and process noise. The state of system 402 comprising autonomous vehicle 404 is represented by state vector x (405). State vector 405 is a vector that contains information about the state of system 402. The kth element of the state vector 405 is represented as xₖ. The state vector contains information about the position, velocity, and acceleration of autonomous vehicle 404. The kth element of the state vector is used to track the state of the system over time.

The state vector encapsulates various variables defining the car's current status. These variables include positional coordinates (x, y in 2D space), velocity (with directional components), linear and angular acceleration (indicating changes in velocity over time), orientation (described using angles like yaw, pitch, and roll), and angular velocity (the rate of angular position change). Additionally, control inputs such as steering angle, throttle, and brake might also be incorporated.

The kth element of a vector is the cost of the kth rollout from a given time onward. For example, given a vector dxt with 4 elements, the first element would be the cost to go from time t0 to t1, the second element would be the cost to go from time t1 to t2, and so on. The kth rollout is the trajectory of the system starting from the initial state x(t0) and using the control input sequence u0, u1, . . . , uk−1.

Sensor 406 records state information such as position, velocity, and acceleration of autonomous vehicle 404. In an embodiment, sensor 406 represents a number of sensors, including camera 407. Camera 407 records driving-scenario data, such as images along a path. In an embodiment, the path is a public or private roadway. The output of camera 407 is image data 409. Image data 409, along with prompt 411 is passed to LVLM 412. Prompt 411 represents one or more prompts that query LVLM 412 about image data 409. LVLM 412 has been trained on image-pairs as described above and outputs descriptions 414 to MPPI Controller 418. The output of sensor 406 is passed as state vector 408, which includes state vector 405 plus noise, to MPPI Controller 418. State information for system 402 inherently includes some noise due to the nature of system 402. The state received by MPPI Controller 412 is thus state 408, which refers to the system state vector 405 plus process noise inherent in system 408. Noise in this context is used to model uncertainty in the system dynamics, such as unmodeled forces or sensor noise.

MPPI Controller 418 acts on descriptions 414 as described in connection with FIG. 1 above. State vector 408 and LVLM descriptions 414 are both used as inputs for calculating cost coefficients.

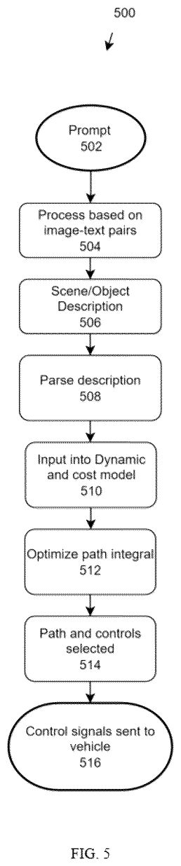

Referring to FIG. 5 is a flowchart of a method 500 for navigating a path by an autonomous vehicle in motion is depicted, according to an embodiment. Starting with prompt 502, which corresponds to prompt 411 of FIG. 4, the LVLM is queried with respect to image data being received by a camera associated with an autonomous vehicle. The LVLM processes the query at 504 using image-text pairs in accordance with its training and any fine-tuning. The LVLM outputs a scene and object description at 506. At 508, the descriptions from 506 are received at the MPPI Controller and parsed. The parsed descriptions are passed as input to a dynamic model and a cost model at 510. The path integral is optimized at 512. Path and controls are selected accordingly at 514 to implement the optimal path by way of control signals sent to the autonomous vehicle at 516.

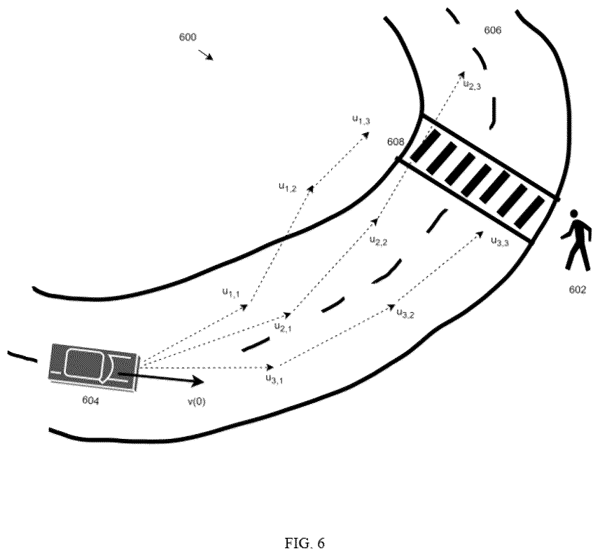

Referring to FIG. 6, a diagram of a roadway scenario illustrating a path-selection process is depicted, according to an embodiment. Driving scenario 600 is shown with a pedestrian 602 and an autonomous vehicle 604 in roadway 606. Pedestrian 602 is moving toward crosswalk 608. The current velocity of autonomous vehicle 604 is shown by the arrow labeled vₒ. Three possible rollouts for autonomous vehicle 604 are labeled u₁, u₂, and u₃. Cost calculations are made at three points along each of paths u₁, u₂, and u₃. These points are marked as points u_{1,1}, u_{1,2}, and u_{1,3} for rollout u₁. Rollouts u₂ and u₃ are marked similarly.

Rollout u₁ is an example of a rollout for which the cost is unlikely to be affected by pedestrian 602. The cost of rollout u₁ will be relatively high in any event because this rollout leaves the roadway at u_{1,2} even if pedestrian 602 does not enter crosswalk 608. For this rollout, the MPPI controller's calculation of the cost function will not be affected by the LVLM's identification of pedestrian 602 in crosswalk 608.

The cost of rollout u₂ will be less because the path is entirely within the roadway. At u_{2,2} the cost function will potentially be affected by the path of pedestrian 602. If pedestrian 602 has entered crosswalk 608 the cost for the path from u_{2,2} to u_{2,3} will increase as a result of LVLM recommendations. If pedestrian 602 has not entered crosswalk 602, the cost function will be unaffected and path u₂ has a better chance of being chosen as the optimal path.

Rollout u₃ reflects a determination by the LVLM that pedestrian 602 is entering crosswalk 608. The cost of the path segment u_{3,2} to u_{3,3} will be low because this path avoids pedestrian 602. Thus, the path-selection process will be affected by increasing path costs added by the LVLM's analysis of driving scenarios. The LVLM is thereby integrated with the MPPI Controller and influences the path integral. The integrated system enhances the safety and efficiency of autonomous vehicle 604 by factoring sensor data (e.g. camera images) of various driving scenarios and LVLM descriptions into the calculation of path cost, ultimately leading to the selection of better trajectories by the MPPI Controller.

1. A method for navigating a path by an autonomous vehicle in motion, the method comprising:
collecting image data along the path with a camera operably coupled to the autonomous vehicle in motion;
passing a slice of collected image data encoded with a feature extractor to a large vision language model (LVLM), wherein the LVLM has been pretrained and wherein the LVLM has been tuned with image-pairs from driving environments;
passing a text-based query related to an aspect of driving to the LVLM;
outputting from the LVLM driving instructions in a structured, machine-readable format;
passing the outputted driving instruction from the LVLM to a Model Predictive Path Integral (MPPI) module operably coupled to the autonomous vehicle;
wherein the MPPI module is configured to calculate a plurality of possible paths using a cost model;
parsing the driving instructions from the LVLM and inputting the parsed driving instructions into the cost model;
assigning, by the MPPI module, a change in cost of one of the plurality of possible calculated paths based on the driving instructions from the LVLM;
selecting, with the MPPI module, the lowest cost path from among the possible calculated paths based on the change in cost assigned by the MPPI module.

2. The method of claim 1, wherein the text-based query is a prompt sent in accordance with a predetermined schedule.

3. The method of claim 1, wherein the driving instructions comprise a scene description and an object description.

4. The method of claim 1, wherein the LVLM is pre-trained on a dataset comprising video/image-caption pairs, wherein the video/image-caption pairs comprise images commonly observed on roadways combined with text captions.

5. The method of claim 1, wherein selecting the lowest cost path includes applying an optimizer using a Monte Carlo approximation.

6. The method of claim 4, wherein the LVLM is tuned on a dataset comprising visual-instruction pairs, wherein images commonly observed on roadways are linked with instructions.

7. The method of claim 6, wherein the instructions comprise commands to stop or to use caution.

8. A system for navigating a path by an autonomous vehicle in motion, the system comprising:
an autonomous vehicle coupled with a plurality of sensors for collecting image data from the environment;
wherein the plurality of sensors are configured to pass a slice of the collected image data to a Large Vision Language Model (LVLM), wherein the LVLM has been pretrained with image-pairs from driving environments;
wherein the LVLM is configured to receive a text-based query related to an aspect of driving and output driving instructions in a structured, machine-readable format to a Model Predictive Path Integral (MPPI) control module operably coupled to the autonomous vehicle;
wherein the MPPI module is configured to calculate a plurality of possible paths using a cost model;
wherein the MPPI module is configured to receive structured, machine-readable driving instructions from the LVLM and to input parsed driving instructions into the cost model;
wherein the MPPI module is configured to assign a change in cost of one of the plurality of possible paths based on the driving instructions from the LVLM; and
wherein the MPPI module is configured to select a lowest cost path from among the plurality of possible paths based on the change in cost assigned by the MPPI module.

9. The system of claim 8, wherein the text-based query is a prompt sent in accordance with a predetermined schedule.

10. The system of claim 8, wherein the driving instructions comprise a scene description and an object description.

11. The system of claim 8, wherein the LVLM is pre-trained on a dataset comprising video/image-caption pairs, wherein the video/image-caption pairs comprise images commonly observed on roadways, combined with text captions.

12. The system of claim 8, wherein the MPPI module is configured to select the lowest cost path by applying an optimizer using a Monte Carlo approximation.

13. The system of claim 11, wherein the LVLM is tuned on a dataset comprising visual-instruction pairs, wherein visual instruction pairs comprise images commonly observed on roadways are linked with instructions.

14. The system of claim 13, wherein the instructions comprise commands to stop or to use caution.

15. The system of claim 8, wherein the plurality of sensors comprises at least one of a camera, LiDAR, radar, or GPS.

16. The system of claim 8 wherein the LVLM is built from a generative pretrained transformer.

17. A method for training a Large Language Model (LLM) for trajectory calculation when integrated with an MPPI controller, the method comprising:
providing a first dataset of image pairs to the LLM, wherein the image pairs comprise images from roadway scenarios and text labels;
providing a second dataset of images paired with driving instructions,
training the LLM on the first dataset;
fine-tuning the LLM on the second dataset;
passing an image of a roadway scenario to the LLM;
prompting the LLM with a text query related to the image from a roadway scenario;
receiving, by a Model Predictive Path Integral (MPPI) controller, a driving instruction in response to the text query from the LLM in a structured, machine-readable format; and
parsing the driving instruction for input to a cost model.

18. The method of claim 17, wherein the LLM is a generative pretrained transformer.

19. The method of claim 17, further comprising calculating a plurality of possible paths using a cost model.

20. The method of claim 19, further comprising selecting a lowest cost path from among the plurality of possible paths based on a change in cost assigned by the MPPI module.
